(19) United States
(12) Patent Application Publication
(10) Pub. No.: US 2003/0175490 A1
(43) Pub. Date: Sep. 18, 2003

(54) Hybrid code and rubber product

(75) Inventors: Masashi Furukawa, Osaka (JP); Kenichi Nakamura, Osaka (JP); Takeshi Maeda, Osaka (JP)

Correspondence Address: KANESAKA AND TAKEUCHI, 1423 Powhatan Street, Alexandria, VA, 22314, US

(73) Assignee: NIPPON SHEET GLASS CO., LTD.

(21) Appl. No.: 10/405,706

(22) Filed: Apr. 3, 2003

Related U.S. Application Data
(63) Continuation of application No. PCT/JP02/07209, filed on Jul. 16, 2002.

(30) Foreign Application Priority Data
Jul. 24, 2001 (JP) 2001-223306

(51) Int. Cl. B32B 17/02

(52) U.S. Cl. 428/299.4; 442/180

(57) ABSTRACT

There is provided a hybrid code having excellent dimensional stability and flexing resistance for use in a reinforcement of rubber, and a rubber product reinforced with the hybrid code. The hybrid code 1 has glass fiber strands 2 disposed at its center, and aramid fiber strands 3 disposed therearound. Glass fiber filaments applied with RFL treatment are bound to form the strands. A plurality of the strands are primarily twisted at a twisting rate of 1 to 10 turns/25 mm. Aramid fiber filaments applied with RFL treatment are bound to form the strands. A plurality of the strands are primarily twisted at a twisting rate of 1 to 10 turns/25 mm. The glass fiber strands 2 primarily twisted are disposed at a center, and the aramid fiber strands 3 are properly twisted in an opposite direction to the primary twist. The code is overcoated to form a rubber coat.

### CROSS REFERENCE TO RELATED APPLICATION

This is a continuation application of PCT/JPO2/07209 filed on Jul. 16, 2002.

### FIELD OF THE INVENTION

The present invention relates to a hybrid code having excellent flexing resistance and dimensional stability for use in a reinforcement of rubber products such as a rubber belt and a tire, and also relates to a rubber product reinforced with the hybrid code.

### DESCRIPTION OF THE RELATED ART

Reinforcement fibers are embedded into rubber products including a rubber belt and a rubber tire, in order to improve strength and durability of the rubber products.

Examples of the reinforcement fibers include a glass fiber, a polyvinyl alcohol fiber such as a vinylon fiber, a polyester fiber, a polyamide fiber such as nylon and aramid, i.e., aromatic polyamide, a carbon fiber, a polyparaphenylene benxoxazole fiber and the like. The glass fiber and the aramid fiber are suitable, and are widely used.

A rubber reinforcing code made of the glass fiber has high dimensional stability, but has lower retention of strength when it is bent by a small diameter pulley for a long time than that of a rubber reinforcing code made of the aramid fiber. On the other hand, the aramid fiber code has good flexing resistance, but has poor dimensional stability as compared with the glass fiber code.

### SUMMARY OF THE INVENTION

A hybrid code of the present invention comprises at least one twisted glass fiber strand, and a plurality of aramid fiber strands twisted together, wherein the glass fiber strand is disposed at a center of the hybrid code, and the aramid fiber strands are disposed around the glass fiber strand.

According to the present invention, there is provided a hybrid code having excellent flexing resistance and dimensional stability, and a rubber product reinforced with the hybrid code.

As described above, when the aramid fiber code is made into a belt, it has higher flexural fatigue resistance, but lower dimensional stability than that of the glass fiber code. On the other hand, the glass fiber code has excellent dimensional stability, but has lower flexural fatigue resistance than that of the aramid fiber code. The hybrid code of the present invention has both of the dimensional stability of the glass fiber code and the flexural fatigue resistance of the aramid fiber code.

In order to improve the flexing resistance of the rubber reinforcing code, the strands of the code are twisted.

When the rubber belt reinforced with the rubber reinforcing code is bent, the code is strongly compressed at a contact side with the pulley as the diameter of the code is greater, and at the opposite side, the code is strongly stretched. Accordingly, in the glass fiber code, when the diameter of the code is smaller, a difference between the compression and the stretch can be small, thereby improving the flexing resistance.

The aramid fiber code has greater elongation than that of the glass fiber code, and therefore has poor dimensional stability as compared with the glass fiber.

The hybrid code of the present invention comprises the glass fiber strands having good dimensional stability as a core material, and the aramid fiber strands disposed around the core material. The aramid fiber strands are prevented from elongating by the core material comprising the glass fiber strands. Thus, the hybrid code of the present invention has excellent dimensional stability. The aramid fiber strands disposed around the core material provide their excellent flexing resistance to the code.

According to the hybrid code of the present invention, the glass fiber strands are disposed only at a center of the code. A plurality of the glass fiber strands collected may be used as the core. In order to improve the flexing resistance of the code, the glass fiber code has preferably a small diameter.

A rubber product of the present invention comprises rubber and the aforementioned hybrid code embedded within the rubber. The rubber product preferably contains 10 to 70% by weight of the hybrid code.

### BRIEF DESCRIPTION OF THE DRAWINGS

FIG. 1 is a sectional view of a hybrid code according to an embodiment of the present invention;

FIG. 2 is a schematic perspective view showing a method of producing the hybrid code; and

FIG. 3 is an illustration of a method of flexural fatigue test in Examples and Comparative Examples.

### DESCRIPTION OF THE PREFERRED EMBODIMENTS

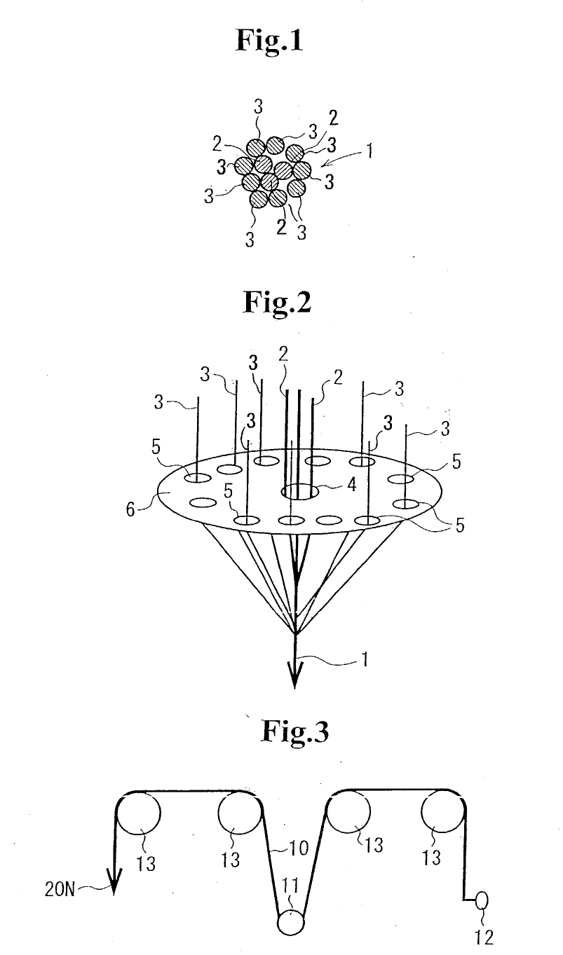

Referring to Figures, preferred embodiments will be described below. FIG. 1 is a sectional view of a hybrid code according to an embodiment, and FIG. 2 is a schematic perspective view showing a method of producing the hybrid code.

As shown in FIG. 1, the hybrid code 1 includes at least one glass fiber strand 2 disposed at a center of a cross-section perpendicular to a longitudinal direction of the code 1, and a plurality of aramid fiber strands 3 disposed therearound.

Filaments of glass fibers for use in the glass fiber strand may be an E glass fiber filament, and a high strength glass fiber filament.

An aramid fiber for use in the aramid fiber strands may be a para-aramid fiber or a meta-aramid fiber. Filaments of the para-aramid fiber are available from Teijin Limited under the trademark of “TECHNORORA” which is copolyparaphenylene-3,4′-oxydiphenylene terephthalamide, and from Teijin Twaron Limited under the trademark of “Twaron” which is polyparaphenylene terephthalamide. Filaments of the meta-aramid fibers are available from Teijin Limited under the trademark of “CONEX”, which is polymethaphenylene isophthalamide. It is noted that the aramid fiber is not limited thereto.

As shown in FIG. 2, the hybrid code 1 is produced using a guide 6 having a center guide hole 4, and peripheral guide holes 5. Each peripheral guide hole 5 is disposed at approximately equal distance from the center guide hole 4.

Inside and edge of each hole 4, 5 are composed of ceramic with smooth surface. The plurality of glass fiber strands 2 primarily twisted are passed through the center guide hole 4, and the aramid fiber strands 3 primarily twisted are passed through the peripheral guide holes 5. These strands 2, 3 are properly twisted together to provide the hybrid code 1. It is preferable that a twisting rate in the proper twist be about 1 to 10 turns/25 mm.

In the present invention, the glass fiber filaments applied with treatment RLF are preferably bound to form the strands, and the predetermined number of lines of strands are primarily twisted together at the twisting rate of 1 to 10 turns/25 mm. A predetermined number of lines of the aramid fiber filaments also applied with RLF treatment are preferably bound and primarily twisted at the twisting rate of 1 to 10 turns/25 mm.

The RFL treatment is conducted by immersing the filaments into a treating liquid (hereinafter referred to as “RFL”) comprising a mixture of an initial condensation product of resorcin and formalin and rubber latex as a main component, and then heating them. Non-limiting examples of the rubber latex for use in the RFL treatment include acrylic rubber based latex, urethane based latex, styrene-butadiene rubber based latex, nitrile rubber based latex, chlorosulfonated polyethylene based latex, modified latexes thereof, and a mixture thereof.

According to the present invention, a rubber coat may be formed on a surface of the hybrid code produced as shown in FIG. 2. Thus, the hybrid code may be overcoated with rubber in order to enhance affinity between the code and a rubber product. As the rubber of the overcoat, hydrogenated nitrile rubber, chlorosulfonated polyethylene rubber, chloroprene rubber, natural rubber and urethane rubber and the like can be used. In many cases, the same rubber as that to be molded into a product is used. The overcoat rubber employed is not especially limited thereto.

The hybrid code of the present invention is suitably used in reinforcing a belt, i.e., a moving belt, a crawler, and other rubber members. It is preferable that about 10 to 70% by weight of the hybrid code is contained in the rubber product.

### EXAMPLES

The Examples of the present invention will be described below.

### Example 1

Three high strength glass fiber strands comprising 200 lines of filaments each having a fiber diameter of 7 μm were grouped together without being twisted. The strands were applied with RFL treatment using an RFL containing chlorosulfoanted polyethylene based latex so that an RFL deposition was about 25% by weight on a solid basis.

Aramid fiber filaments each having a fiber diameter of 12 μm and 400 denier manufactured by Teijin Limited under the trademark of “TECHNORORA” were applied with RLF treatment so that an RFL deposition was about 25% by weight on a solid basis similar to the glass fiber filaments.

The glass fiber filaments treated with RFL and the aramid fiber filaments treated with RFL were primarily twisted at a twisting rate of 2 turns/25 mm respectively to provide glass fiber strands and aramid fiber strands.

Then, three glass fiber strands were passed through the guide hole 4 at the center of the guide 6 shown in FIG. 2 Eight aramid fiber strands were passed through eight guide holes 5 at a peripheral part of the guide 6 shown in FIG. 2, respectively. These were properly twisted at a twisting rate of 2 turns/25 mm in the opposite direction to that of the primary twist. Thus, there was provided a properly twisted glass fiber-aramid fiber hybrid naked code in which the three glass fiber strands were disposed at the center, and the eight aramid fiber strands were disposed therearound.

The thus-obtained properly twisted naked code was overcoated with an overcoat treating liquid containing chlorosulfonated polyethylene rubber and chloroprene rubber, in order to further improve adhesion with the matrix resin, resulting in a glass fiber-aramid fiber hybrid code.

The resulting glass fiber-aramid fiber hybrid code has elongation at break of 4.60%.

Then, the glass fiber-aramid fiber hybrid code was pressed and heated together with the hydrogenated nitrile rubber (hereinafter referred to as HSN) to form an HSN rubber molded product in which single glass fiber-aramid fiber hybrid code was embedded.

The HSN rubber molded product was cut so that the glass fiber-aramid fiber hybrid code was at the center of the rubber molded product, whereby a belt-shaped molded product with a width of 10 mm was formed.

As shown in FIG. 3, the belt-shaped molded product 10 was set on a testing machine comprising a flat pulley 11 with a diameter of 25 mm, a motor 12 and four guide pulleys 13, and was hung over the pulleys 11, 13. The belt 10 was reciprocated by the motor 12, and was bent repeatedly at a part along the flat pulley 11. The belt 10 was applied with initial tension of 20N and then bent 100,000 times at room temperature. After bending, the strength and the retention of strength of the belt 10 were determined for evaluating flexural fatigue resistance thereof.

As a result, the belt had the strength of 880 N and the retention of strength of 87% after bending.

### Example 2

The RLF treatment was conducted similar to Example 1 except that the RFL deposition on the glass fiber filaments and the aramid fiber filaments was about 20% by weight on a solid basis. Respective fiber filaments were primarily and properly twisted, and overcoated similar to Example 1. Four glass fiber strands and seven aramid fiber strands were used to produce the glass fiber-aramid fiber hybrid code similar to Example 1. The hybrid code was used to produce the rubber belt similar to Example 1.

The resulting hybrid code had elongation at break of 4.52%. As a result of the flexural fatigue test, the rubber belt had the strength of 845 N and the retention of strength of 83% after bending.

### Example 3

The same operation was conducted similar to Examples 1 and 2 except that the RFL deposition on the glass fiber filaments and the aramid fiber filaments was about 15% by weight on a solid basis. Five glass fiber strands and six aramid fiber strands were used to produce the glass fiber-aramid fiber hybrid code similar to Example 1. The hybrid code was used to produce the rubber belt similar to Example 1.

The resulting hybrid code had elongation at break of 4.56%. As a result of the flexural fatigue test, the rubber belt had the strength of 820 N and the retention of strength of 80% after bending.

### Comparative Examples 1 to 3

As to Comparative Example 1, three glass fiber strands and eight aramid fiber strands that were the same as Example 1 were randomly twisted together to produce the code. As to Comparative Example 2, a code was produced by using eleven glass fiber strands. As to Comparative Example 3, a code was produced by using eleven aramid fiber strands alone. Elongation at break of each code was measured. Respective belt products formed by using respective codes were tested for the strength and the retention of strength after bending. These results are shown in TABLE 1.

TABLE 1

| | | | Strength | Retention of |
|---|---|---|---|---|
| | | Elongation at | after | strength after |
| | | break of | bending of | bending of |
| | Twist conditions | code (%) | belt (N) | belt (%) |
| Example 1 | Center: three | 4.60 | 880 | 87 |
| | glass fibers, | | | |
| | Peripheral: eight | | | |
| | aramid fibers | | | |
| Example 2 | Center: four | 4.52 | 845 | 83 |
| | glass fibers, | | | |
| | Peripheral: seven | | | |
| | aramid fibers | | | |
| Example 3 | Center: five | 4.56 | 820 | 80 |
| | glass fibers, | | | |
| | Peripheral: six | | | |
| | aramid fibers | | | |
| Comparative | Random twisted, | 523 | 740 | 73 |
| Example 1 | Three glass | | | |
| | fibers, Eight | | | |
| | aramid fibers | | | |
| Comparative | Eleven glass | 4.48 | 630 | 60 |
| Example 2 | fibers | | | |
| Comparative | Eleven aramid | 6.62 | 905 | 93 |
| Example 3 | fibers | | | |

As is apparent from TABLE 1, the glass fiber-aramid fiber hybrid code of the present invention has excellent elongation at break similar to the glass fiber code of Comparative Example 2, and excellent flexing resistance similar to the aramid fiber code of Comparative Example 3. The belt-shaped molded product formed using the glass fiber-aramid fiber hybrid code has excellent strength and retention of strength after bending similar to the aramid fiber code. Comparative Example 1 has poor elongation, strength and retention of strength as compared with Examples 1 to 3.

### INDUSTRIAL AVAILABILITY

As aforementioned, according to the present invention, there is provided a hybrid code having excellent flexing resistance and dimensional stability, and a rubber product reinforced with the hybrid code.

What is claimed is:

1. A hybrid code, comprising at least one glass fiber strand, and a plurality of aramid fiber strands twisted together,
wherein the glass fiber strand is disposed at a center of the hybrid code, and the aramid fiber strands are disposed around the glass fiber strand.

2. A hybrid code according to claim 1, wherein the glass fiber strand and the aramid fiber strands are primarily twisted at a twisting rate of 1 to 10 turns/25 mm, respectively.

3. A hybrid code according to claim 1 or 2, wherein the glass fiber strand that is primary twisted and the aramid fiber strands that is primary twisted are properly twisted together at a twisting rate of 1 to 10 turns/25 mm.

4. A hybrid code according to any one of claims 1 to 3, wherein both of the glass fiber and the aramid fiber are subjected to an RFL treatment.

5. A hybrid code according to claim 4, wherein the RFL treatment is conducted by immersing filaments into a treating liquid comprising a mixture of an initial condensation product of resorcin and formalin and rubber latex as a main component, and then heating them.

6. A hybrid code according to claim 5, wherein the rubber latex is at least one selected from the group consisting of acrylic rubber based latex, urethane based latex, styrene-butadiene rubber based latex, nitrile rubber based latex, chlorosulfonated polyethylene based latexes, and modified latexes thereof.

7. A hybrid code according to any one of claims 4 to 6, wherein the RLF treatment liquid is deposited on the hybrid code in an amount of 5 to 30% by weight on a solid basis.

8. A hybrid code according to any one of claims 1 to 7, further comprising a rubber coat for overcoating the hybrid code.

9. A hybrid code according to claim 8, wherein the rubber coat is at least one selected from the group consisting of hydrogenated nitrile rubber, chlorosulfonated polyethylene rubber, chloroprene rubber, natural rubber and urethane rubber.

10. A hybrid code according to claims 8 or 9, wherein the rubber coat is deposited on the hybrid code in an amount of 2 to 10% by weight.

11. A reinforced rubber product comprising rubber and a reinforcing code embedded within the rubber, wherein the code is the hybrid code according to any one of claims 1 to 10.

12. A reinforced rubber product according to claim 11, wherein 10 to 70% by weight of the hybrid code is contained.
